(19) United States
(12) Patent Application Publication
(10) Pub. No.: US 2024/0300570 A1
(43) Pub. Date: Sep. 12, 2024

(54) ROTARY ASSIST APPARATUS FOR RECIRCULATING BALL STEERING GEARS

(71) Applicant: Ford Global Technologies, LLC, Dearborn, MI (US)

(72) Inventor: Joseph Washnock, Canton, MI (US)

(21) Appl. No.: 18/181,394

(22) Filed: Mar. 9, 2023

(51) Int. Cl. B62D 5/04

(52) U.S. Cl. CPC B62D 5/0448; B62D 5/0454

(57) ABSTRACT

Rotary assist apparatus for recirculating ball steering gears are disclosed. An example system includes a worm gear, a ring gear fixed to an end of the worm gear, a ball nut surrounding a portion of the worm gear, a first intermediate gear fixed to a first pinion, the first intermediate gear and the first pinion aligned along a first axis of rotation, the first pinion engaged with the ring gear, a second intermediate gear fixed to a second pinion, the second intermediate gear and the second pinion aligned along a second axis of rotation different than the first axis of rotation, the second pinion engaged with the first intermediate gear, and a motor fixed to a third pinion, the third pinion engaged with the second intermediate gear or a third intermediate gear, the motor to rotate the worm gear to translate the ball nut.

### FIELD OF THE DISCLOSURE

This disclosure relates generally to steering systems and, more particularly, to a rotary assist apparatus for recirculating ball steering gears.

### BACKGROUND

Known vehicles typically include a mechanical linkage that connects front wheels of a vehicle to a steering wheel, which allows a driver to adjust the orientation of the front wheels by rotating the steering wheel. For example, many known steering systems include rack and pinion gears that translate rotational motion of a steering wheel to linear actuation or movement of a drag link and/or tie rods connected to the front wheels. As the steering wheel rotates, the drag link and/or the tie rods change the angular orientation of the wheels and steer the vehicle.

In recent years, trucks have utilized hydraulic assist recirculating ball (RCB) steering systems. The hydraulic assist of the RCB steering systems is provided by a pump that transports hydraulic steering fluid to the RCB system. In some implementations, electronic torque overlay mechanisms are utilized to provide an electric steering feel to the hydraulic system.

### SUMMARY

An example rotary assist apparatus for recirculating ball steering gears is disclosed herein. An example vehicle steering system includes a worm gear. A ring gear is fixed to an end of the worm gear. A ball nut surrounds a portion of the worm gear. The ball nut includes ball bearings and ball guides. A first intermediate gear is fixed to a first pinion. The first intermediate gear and the first pinion are aligned along a first axis of rotation. The first pinion is engaged with the ring gear. A second intermediate gear is fixed to a second pinion. The second intermediate gear and the second pinion are aligned along a second axis of rotation different than the first axis of rotation. The second pinion is engaged with the first intermediate gear. A motor is fixed to a third pinion. The third pinion is engaged with the second intermediate gear or a third intermediate gear. The motor is to rotate the worm gear to translate the ball nut. A sector gear is engaged with the ball nut. The sector gear is to rotate as the ball nut translates.

An example apparatus includes a worm gear fixed to a ring gear. A first gear set includes a pinion of a motor engaged with a first intermediate gear. A second gear set includes a pinion of the first intermediate gear engaged with a second intermediate gear. A third gear set includes a pinion of the second intermediate gear engaged with the ring gear or a third intermediate gear. A fourth gear set includes a ball nut engaged with a portion of the worm gear. The ball nut is to translate as the worm gear rotates.

An example apparatus includes a worm gear fixed to a ring gear. The worm gear and the ring gear are aligned along a first axis of rotation. A first intermediate gear is fixed to a first pinion. The first intermediate gear and the first pinion are aligned along a second axis of rotation parallel to the first axis of rotation. The first pinion engaged with the ring gear. A motor fixed to a second pinion. The motor and the second pinion are aligned along a third axis of rotation parallel to the second axis of rotation. The second pinion is engaged with the first intermediate gear or a second intermediate gear.

### BRIEF DESCRIPTION OF THE DRAWINGS

FIG. 1 illustrates a steering system in an under-hood environment of a vehicle.

FIG. 2 illustrates a view of a portion of the steering system of FIG. 1.

FIG. 3 illustrates another view of a portion of the steering system of FIGS. 1 and 2.

FIG. 4 illustrates an example cross-section of the steering system of FIGS. 1, 2, and 3.

FIG. 5 illustrates another view of a portion of the steering system of FIGS. 1, 2, 3, and 4.

FIG. 6A illustrates a first example implementation of a portion of the steering system of FIGS. 1, 2, 3, 4, and 5.

FIG. 6B illustrates a second example implementation of a portion of the steering system of FIGS. 1, 2, 3, 4, and 5.

FIG. 6C illustrates a third example implementation of a portion of the steering system of FIGS. 1, 2, 3, 4, and 5.

FIG. 7A illustrates a portion of another steering system that can be implemented in the under-hood environment of FIG. 1.

FIG. 7B illustrates another view of the steering system of FIG. 7A.

FIG. 8 illustrates a portion of another steering system that can be implemented in the under-hood environment of FIG. 1.

In general, the same reference numbers will be used throughout the drawing(s) and accompanying written description to refer to the same or like parts. The figures are not substantially to scale.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,”“second,”“third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified in the below description.

### DETAILED DESCRIPTION

Disclosed herein are example electrically powered rotary assist mechanisms for recirculating ball (RCB) steering gear systems. Traditionally, some heavy-duty trucks have utilized a steering mechanism including hydraulically assisted RCB gears or worm and wheel steering gears. In some instances, a pump provides the hydraulic assist to the RCB gears by pumping hydraulic steering fluid through the steering system. In some such instances, as the steering wheel is turned, a steering shaft rotates to cause a piston of the RCB gears to move linearly. In turn, the piston rotates a sector that is coupled to a pitman arm that turns the wheels. The hydraulic steering fluid is pumped to assist the movement of the piston based on the rotation of the steering shaft. However, hydraulic assist RCB gears lack precision in steering feel compared to electrically powered steering. Further, continuous pumping of a hydraulic pump causes a parasitic engine power loss and, thus, reduces an efficiency of the engine.

Known electrically powered steering systems utilize an electrically powered motor instead of the hydraulic pump and the associated piston to move a ball nut. However, the electrically powered steering systems often lack power compared to the hydraulic assist steering. As such, heavier vehicles, such as trucks and/or buses, typically utilize hydraulic assist steering.

Examples disclosed herein provide rotary assist apparatus for RCB steering gears. The example rotary assist apparatus generate sufficient power for relatively heavy vehicles such as trucks to utilize electrically powered steering systems. Non-limiting examples of vehicles disclosed herein include internal combustion engine vehicles, battery electric vehicles, hybrid electric vehicles, fuel-cell vehicles, etc. Although the rotary assist apparatus for RCB steering systems generate enough power to steer trucks, it should be understood that examples disclosed herein may be implemented in any other steerable vehicle. An example steering system (e.g., a steering actuator) disclosed herein includes an input shaft coupled to a steering shaft of a vehicle. In some examples, a driver rotates the input shaft by turning a steering wheel operatively coupled to the steering shaft. In some examples, the input shaft is coupled to a first end of a worm gear while a second end of the worm gear is fixed to a ring gear. The worm gear and the ring gear are aligned along a first axis of rotation. The steering system also includes a ball nut surrounding a portion of the worm gear. The ball nut includes ball bearings and ball guides to convert a rotation of the worm gear into a translation of the ball nut. In some examples, a sector gear, that is engaged with the ball nut, rotates as the ball nut translates. The steering actuator also includes a splined shaft that extends from the sector gear and a pitman arm that couples to the splined shaft. The pitman arm is coupled to a drag link, which is connected to a wheel of the vehicle. As a result, the rotation of the sector gear moves the pitman arm. In turn, the movement of the pitman arm is converted to movement of the wheels via the drag link, one or more tie rod(s), and/or a knuckle of the steering wheels.

The steering actuator includes a motor that outputs a torque for electrically powered steering. For example, the torque can be based on an angular position of the steering wheel and/or an input from an autonomous driving system. The steering actuator also includes at least one intermediate gear and at least two pinions to increase the torque between the motor and the ring gear. As a result, the steering actuator is able to generate sufficient torque to turn the wheels of heavier vehicles. More particularly, the steering actuator includes a first pinion coupled to a shaft of the motor and engaged with an intermediate gear. Further, a second pinion can be fixed to (e.g., coupled to a same shaft as) the intermediate gear such that the second pinion rotates when the first pinion rotates the intermediate gear. The second pinion is engaged with a second intermediate gear, which is rotated by the second pinion. A third pinion is fixed to the second intermediate gear and rotates therewith. In some examples, the third pinion is engaged with another intermediate gear that is fixed to another pinion to further increase a combined gear reduction between the motor and the ring gear. The third pinion or another pinion is engaged with the ring gear to transfer the torque from the motor to the worm gear.

In the steering actuators disclosed herein, one or more of the intermediate gears and pinions in the steering actuator can be configured based on characteristics of the vehicle associated therewith, such as a weight of the vehicle, space in the vehicle available for the steering actuator, etc. For example, the steering actuator can include an increased number of the intermediate and associated pinion gears where the gears have relatively small sizes while still generating sufficient torque to turn the wheels of heavier vehicles.

Alternatively, the steering actuator can include a reduced number of the intermediate and associated pinion gears having relatively larger sizes to reduce manufacturing and/or assembly costs. In some examples, the steering actuator provides a combined reduction of greater than 100:1. Although examples disclosed herein may provide a gear reduction of greater than 100:1, the gear reduction may range anywhere from 1:1 to greater than 100:1.

Furthermore, a placement of the at least one intermediate gear and at least two pinions is versatile. For example, the at least one intermediate gear, the at least two pinions, and the motor can be positioned anywhere along a 360° orbit of the worm gear given that a pinion is engaged with the ring gear and a pinion of the motor directly or indirectly causes an intermediate gear fixed to the pinion to rotate.

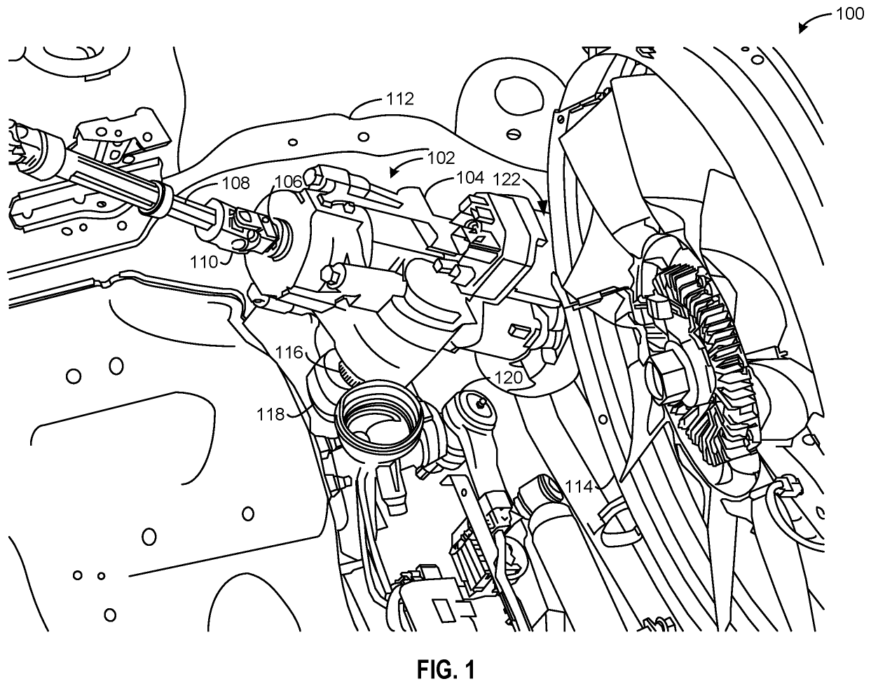

FIG. 1 illustrates a first view of a vehicle steering system (e.g., a steering apparatus, a steering actuator) 102 in an under-hood environment 100 of a vehicle. In FIG. 1, the steering system 102 is positioned within a housing 104. In some examples, the housing 104 includes one or more housings that are coupled to protect the steering system 102. In some examples, an input shaft 106 of the steering system 102 protrudes from the housing 104. In some examples, the input shaft 106 couples to a steering shaft 108 via a connection 110. In some examples, the steering shaft 108 is operatively coupled to a steering wheel of the vehicle. As a result, the input shaft 106 rotates with the steering shaft 108 as a driver rotates the steering wheel. In turn, the steering system 102 converts the rotation of the steering wheel to a rotation of the wheels of the vehicle to steer the vehicle.

In FIG. 1, the steering system 102 is positioned in the under-hood environment 100 between a frame 112 and a fan 114 of the vehicle. Typically, vehicles include the fan 114 to pass air through a radiator and maintain an operating temperature of an engine of the vehicle. Accordingly, the fan 114, the radiator, and the engine take up a significant amount of the space in the under-hood environment 100. The engine of the vehicle is not shown in FIG. 1 to more clearly illustrate a splined shaft 116, a pitman arm 118, and a drag link 120 of the steering system 102. Advantageously, stacked gears and a position of a motor 122 of the steering system 102 enables the steering system 102 to be positioned within relatively small spaces in the under-hood environment 100 while still generating enough power to turn the wheels of heavy trucks. Specifically, the stacked gears provide a combined reduction of greater than 100:1 to generate ample force to turn the wheels.

In some examples, the position of the motor 122 of the steering system 102 is adaptable to the available space of the under-hood environment 100. For example, the motor 122 can be positioned anywhere within a 360° orbit of a worm gear of the steering system 102 given that a pinion of the motor 122 is engaged with an intermediate gear and a pinion of the intermediate gear directly or indirectly drives rotation of a ring gear that is fixed to the worm gear. Additionally, a size of the steering system 102 can be reduced to adapt to the under-hood environment 100.

The splined shaft 116 extends from a sector gear within the housing 104. More particularly, the splined shaft 116 protrudes from a bottom portion of the housing 104 to couple to the pitman arm 118. In some examples, an opening of the pitman arm 118 includes splines that mate with splines of the splined shaft 116. Further, the pitman arm 118 is coupled to the drag link 120, which is connected to a wheel of the vehicle.

In FIG. 1, the steering system 102 causes the splined shaft 116 to rotate in response to a rotation of the steering shaft 108. In turn, the splined shaft 116 moves (e.g., pivots) the pitman arm 118. Further, the pitman arm 118 converts the rotation of the splined shaft 116 into a linear movement of the drag link 120. In some examples, the drag link 120 is connected to a knuckle of a wheel of the vehicle. In some such examples, the linear movement of the drag link 120 adjusts an orientation of the knuckle to turn the wheels. As a result, the steering system 102 converts the rotation of the steering shaft 108 into a movement of the wheels to steer the vehicle.

In some examples, an ample amount of force must be generated to turn the wheels of heavier vehicles, such as trucks. As such, the steering system 102 provides a combined gear reduction of greater than 100:1 to generate the ample amount of force required to steer trucks while utilizing electrically powered steering.

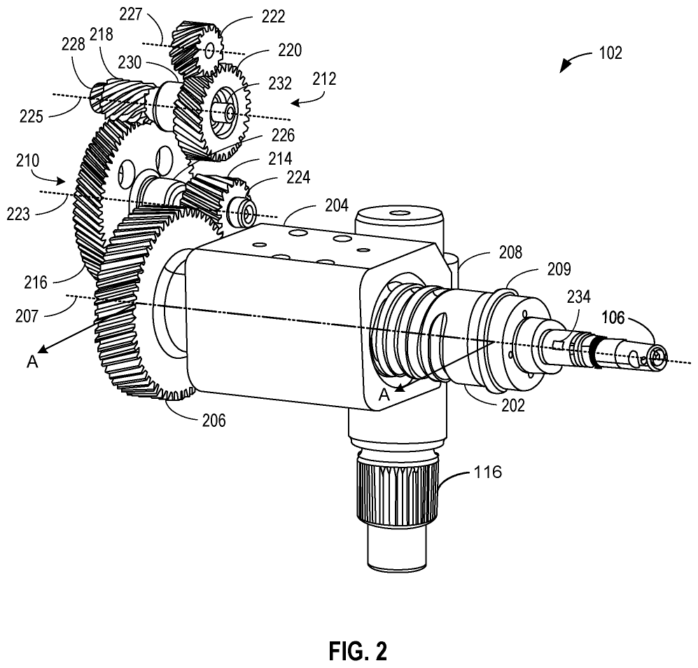

FIG. 2 illustrates the steering system 102 of FIG. 1. In FIG. 2, the steering system 102 includes the input shaft 106, a worm gear 202 engaged with an end of the input shaft 106, a ball nut 204 positioned around a portion of the worm gear 202, and a ring gear 206 fixed to an end of the worm gear 202 opposite the input shaft 106. The worm gear 202 and the ring gear 206 are aligned along a first axis of rotation 207. The steering system 102 includes a bearing 209 (e.g., a bearing and an associated lock ring) disposed around the worm gear 202 to provide support to the worm gear 202 and, in turn, the ball nut 204 and the ring gear 206.

The steering system 102 further includes a sector gear 208 engaged with the ball nut 204. The splined shaft 116 extends from the sector gear 208. A rotation of the worm gear 202 causes the ball nut 204 to translate. For example, the ball nut 204 moves towards the ring gear 206 as the worm gear 202 rotates clockwise in the orientation of FIG. 2 and moves toward the input shaft 106 as the worm gear 202 rotates counterclockwise. Further, the rotation of the ball nut 204 causes the sector gear 208 and the splined shaft 116 to rotate. In turn, the splined shaft 116 pivots the pitman arm 118 of FIG. 1, which moves the drag link 120 and causes the wheels of the vehicle to pivot.

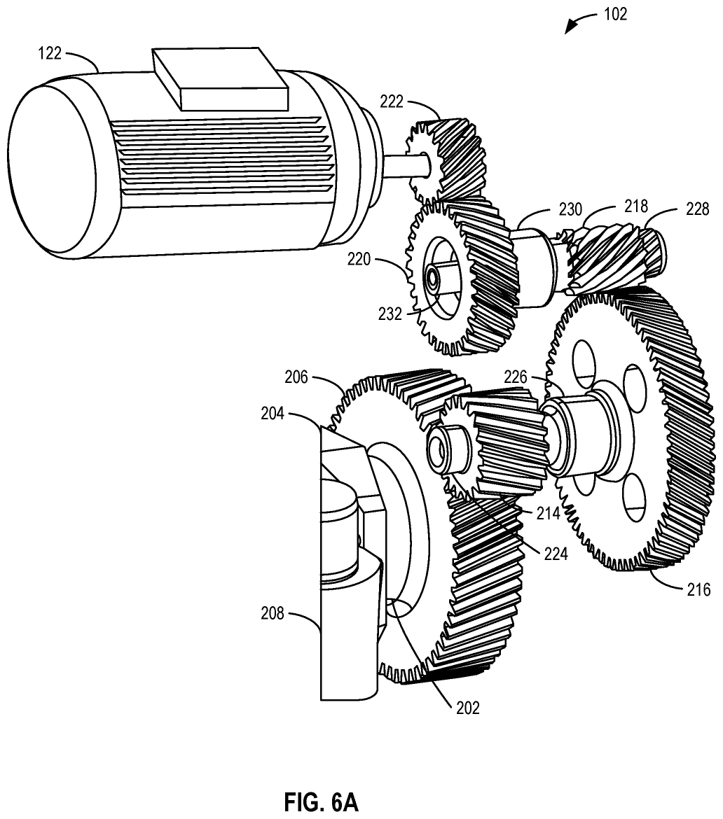

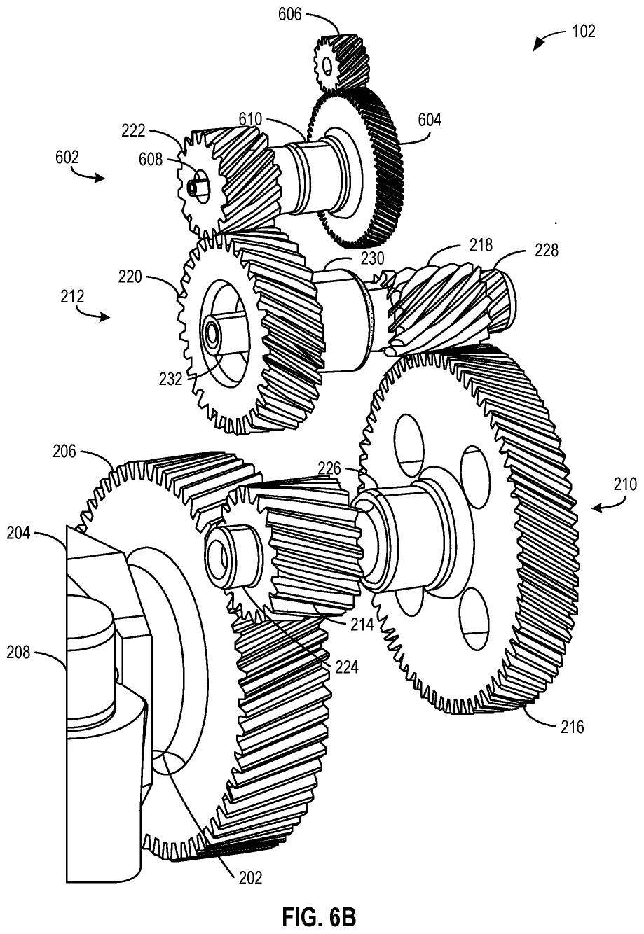

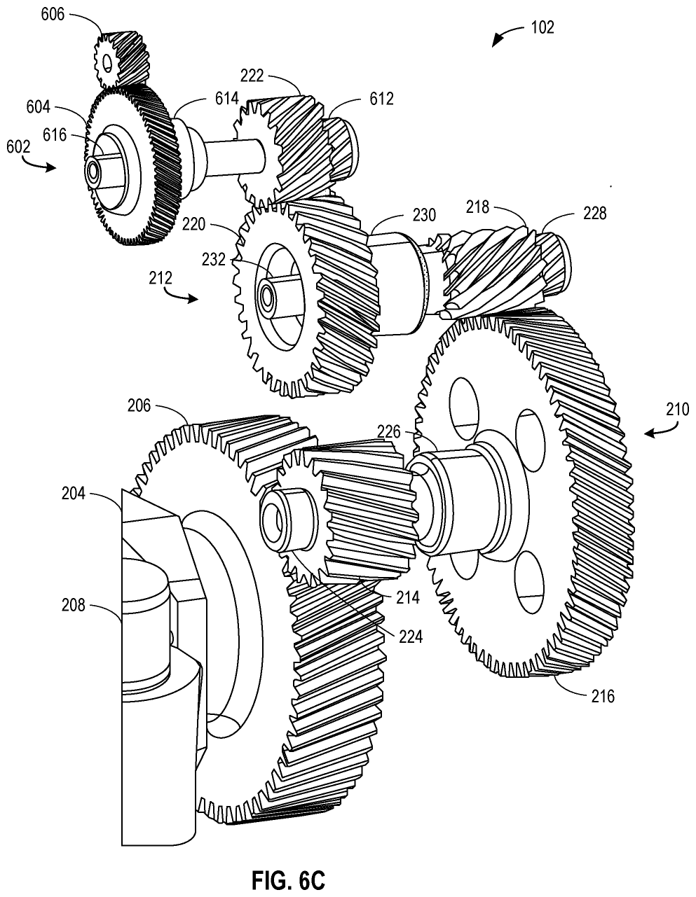

To provide sufficient torque to rotate the worm gear 202, the steering system 102 includes intermediate gear sets 210, 212 to increase and transfer torque provided by the motor 122 to the worm gear 202. More particularly, a first intermediate gear set 210 includes a first pinion 214 fixed to a first intermediate gear 216, and a second intermediate gear set 212 includes a second pinion 218 fixed to a second intermediate gear 220. The steering system 102 also includes a third pinion 222. In some examples, the third pinion 222 is fixed to a third intermediate gear and part of a third intermediate gear set, as discussed further in association with FIGS. 6B and 6C. In some examples, the third pinion 222 is fixed to a shaft of the motor 122, as discussed further in association with FIG. 6A. In the illustrated example of FIG. 2, the first pinion 214 and the first intermediate gear 216 are aligned along a second axis of rotation 223. The second pinion 218 and the second intermediate gear 220 are aligned along a third axis of rotation 225. The third pinion 222 is aligned along a fourth axis of rotation 227. The first, second, third, and fourth axes of rotation 207, 223, 225, 227 are parallel. In some examples, at least two of the first, second, third, and fourth axes of rotation 207, 223, 225, 227 are non-parallel. For example, the third axis of rotation 225 can be non-parallel to the second axis of rotation 223 and/or the fourth axis of rotation 227 so long as the second pinion 218 is operatively engaged with the first intermediate gear 216 and the second intermediate gear 220 is operatively engaged with the third pinion 222.

In FIG. 2, the first pinion 214 is engaged with the ring gear 206 in a first geometric plane. In some examples, the ring gear 206 includes internal gear teeth as opposed to the external gear teeth illustrated in FIG. 2. In such examples, the first pinion 214 is positioned within a circumference of the ring gear 206 and is engaged with the internal gear teeth. The engagement between the first pinion 214 and the ring gear 206 provides a first gear reduction. The first intermediate gear 216 is engaged with the second pinion 218 in a second geometric plane. In FIG. 2, the worm gear 202, the ring gear 206, the first pinion 214, the second intermediate gear 220, and the third pinion 222 are positioned on a same side of the second geometric plane. In FIG. 2, the first intermediate gear 216 includes a first diameter and the second intermediate gear 220 includes a second diameter smaller than the first diameter. As such, the second intermediate gear 220 avoids interfering with the ring gear 206 and/or the first pinion 214. The engagement between the first intermediate gear 216 and the second pinion 218 provides a second gear reduction. The second intermediate gear 220 is engaged with the third pinion 222 in the first geometric plane or a third geometric plane. The first, second, and third geometric planes are parallel to each other and perpendicular to the axes of rotation 207, 223, 225, 227. The engagement between the third pinion 222 and the second intermediate gear 220 provides a third gear reduction. As a result, a layout of the gears 202, 206, 214, 216, 218, 220, 222 provides at least three separate gear reductions, which can provide a combined gear reduction ratio of over 100:1 within a compact space to enable the steering assembly 102 to fit within a variety of under-hood environments and, thus, be utilized in a variety of vehicles. Moreover, a placement of the second axis of rotation 223 is orbital relative to the first axis of rotation 207; a placement of the third axis of rotation 225 is orbital relative to the second axis of rotation 223; and a placement of the fourth axis of rotation 227 is orbital relative to the third axis of rotation 225. As such, the layout of the gears 202, 206, 214, 216, 218, 220, 222 is adaptable based on the particular under-hood environment in which the steering system 102 is to be implemented.

During operation, the motor 122 of FIG. 1 causes the third pinion 222 to rotate, either directly or through an engagement between one or more intermediate gear(s) and pinion(s). Accordingly, the third pinion 222 causes the second intermediate gear 220 to rotate. The second pinion 218 rotates with the second intermediate gear 220 and causes the first intermediate gear 216 to rotate. Further, the first pinion 214 rotates with the first intermediate gear 216 and causes the ring gear 206 to rotate. As a result, the worm gear 202 rotates with the ring gear 206, which translates the ball nut 204 and turns the wheels of the vehicle.

To enable the gear sets 210, 212 to be supported, the steering system 102 includes a first bearing journal 224, a second bearing journal 226, a third bearing journal 228, a fourth bearing journal 230, and a fifth bearing journal 232. The first bearing journal 224 is positioned on a side of the first pinion 214 opposite the first intermediate gear 216. Additionally or alternatively, the first bearing journal 224 can be positioned within a circumference of the first pinion 214. The second bearing journal 226 is positioned between the first pinion 214 and the first intermediate gear 216. Accordingly, the first bearing journal 224 and the second bearing journal 226 can be positioned in respective sleeves or shells for support while enabling the first gear set 210 to rotate. Further, the third bearing journal 228 is positioned on a side of the second pinion 218 opposite the second intermediate gear 220. Additionally or alternatively, the third bearing journal 228 can be positioned within a circumference of the second pinion 218. The fourth bearing journal 230 is positioned between the second pinion 218 and the second intermediate gear 220. The fifth bearing journal 232 is positioned within a circumference of the second intermediate gear 220 and/or on a side of the second intermediate gear 220 opposite the second pinion 218. Accordingly, the third bearing journal 228 and the fourth bearing journal 230 are positioned on an opposite side of the second intermediate gear 220 from the fifth bearing journal 232. The third bearing journal 228, the fourth bearing journal 230, and the fifth bearing journal 232 can be positioned in respective sleeves or shells for support while enabling the second gear set 212 to rotate.

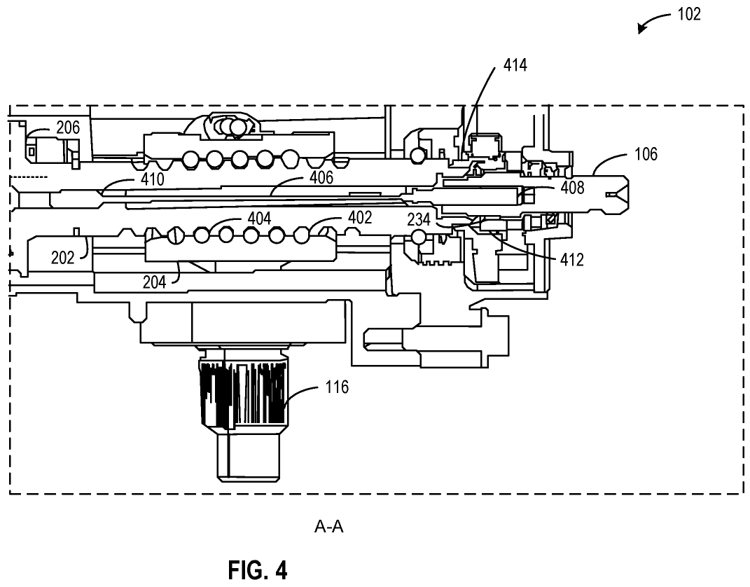

In the illustrated example of FIG. 2, the steering system 102 includes a magnet 234 mounted on the input shaft 106. The steering system 102 further includes a torque sensor positioned around an area of the input shaft 106 within which the magnet 234 is mounted. In some examples, the input shaft 106 is magnetized in place of the magnet 234. As such, the torque sensor measures an angular rotation of the input shaft 106 relative to the worm gear based on a magnetic field of the magnet 234 or the input shaft 106. Further, a portion of the input shaft 106 is positioned within the worm gear 202. In other examples, a portion of the worm gear 202 is positioned within the input shaft 106. In some examples, the portion of the input shaft 106 positioned within the worm gear 202 includes external gear teeth. In some such examples, the worm gear 202 includes internal gear teeth that mesh with the external gear teeth of the input shaft 106. Further, a first end of a torsion bar (not shown) is coupled to an interior of the input shaft 106 and a second end of the torsion bar is coupled to an interior of the worm gear 202, as discussed further in association with FIG. 4. As such, the input shaft 106 is also coupled to the worm gear 202 via the torsion bar. In some examples, the internal gear teeth of the worm gear 202 provide a hard stop at a certain angular rotation of the input shaft 106 to limit a torque applied to the torsion bar. In some such examples, the input shaft 106 and the worm gear 202 rotate together when the hard stop is reached. As such, the hard stop maintains safe operation of the steering system 102 while allowing the torsion bar to hold enough torsion for precise and accurate measurements to be made by the torque sensor. Furthermore, processor circuitry can determine a torque applied to the torsion bar based on the measured angular rotation of the input shaft 106. In turn, the processor circuitry can transmit a corresponding input to the motor 122 based on the determined applied torque. Accordingly, an output of the motor 122 corresponds with an input encountered at the steering wheel of the vehicle.

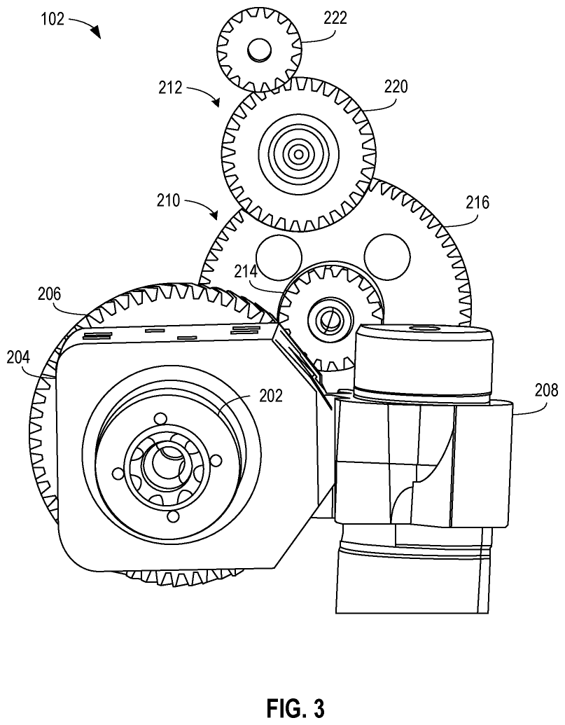

FIG. 3 illustrates another view of a portion of the steering system 102 including the worm gear 202, the ball nut 204, the ring gear 206, the sector gear 208, the first pinion 214, the first intermediate gear 216, the second intermediate gear 220, and the third pinion 222. In the illustrated example of FIG. 3, the second pinion 218 (FIG. 2) is positioned behind the second intermediate gear 220.

FIG. 4 illustrates a cross-section A-A (FIG. 2) of the steering system 102 of FIGS. 1, 2, and 3. In the illustrated example of FIG. 4, the ball nut 204 and the worm gear 202 define ball guides 402 in which ball bearings 404 are positioned to enable the ball nut 204 to translate as the ball nut 204 rotates. As discussed above, the steering system 102 also includes a torsion bar 406. The torsion bar 406 includes a first end 408 coupled to the input shaft 106 and a second end 410 coupled to the worm gear 202. As also discussed above, the steering system 102 also includes a torque sensor 412 to measure a magnetic field of the magnet 234 (FIG. 2) or the input shaft 106. In some examples, the torque sensor 412 is in communication with processor circuitry that determines a rotational position of the input shaft 106 relative to the worm gear 202 based on the magnetic field measured by the torque sensor 412. In some examples, a gear 414 of the torque sensor 412 rotates with the worm gear 202 allowing the torque sensor 412 to provide an indication to the processor circuitry and, in turn, the motor 122 when a target rotation is reached. For example, the torque applied by the input shaft 106 to the torsion bar 406 and/or an angular rotation of the magnet 234 determined by the torque sensor 412 can correspond to a target angular rotation of the worm gear 202. As a result, the motor 122 rotates the worm gear 202 and, in turn, the gear 414 of the torque sensor 412 via the third pinion 222 (FIG. 2), the second gear set 212, the first gear set 210, and the ring gear 206. Further, the processor circuitry or the torque sensor 412 can compare the rotation of the gear 414 to the target angular rotation of the worm gear 202 to determine when the target rotation is reached.

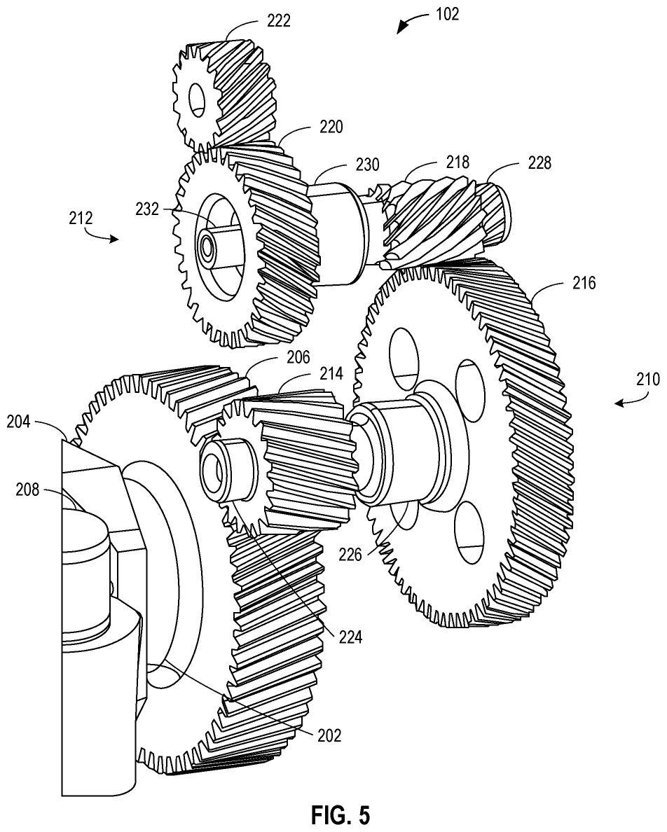

FIG. 5 illustrates another view of a portion of the steering system 102 of FIGS. 1, 2, 3, and 4. In the illustrated example of FIG. 5, the steering system 102 includes the worm gear 202, the ball nut 204, the ring gear 206, the sector gear 208, the first pinion 214, the first intermediate gear 216, the second pinion 218, the second intermediate gear 220, the third pinion 222, the first bearing journal 224, the second bearing journal 226, the third bearing journal 228, the fourth bearing journal 230, and the fifth bearing journal 232. Specifically, FIG. 5 illustrates an arrangement of the third pinion 222 with the intermediate gear sets 210, 212.

FIGS. 6A-6C illustrate different manners in which a remainder of the steering system 102 can be configured to rotate the third pinion 222 and, in turn, the second gear set 212, the first gear set 210, the ring gear 206, and the worm gear 202 to translate the ball nut 204. FIG. 6A illustrates a first example implementation of the portion of the steering system 102 of FIG. 5 in which the third pinion 222 is operatively coupled to, and directly driven by the motor 122 (e.g., a shaft of the motor 122).

FIG. 6B illustrates another example implementation of the portion of the steering system 102 of FIG. 5 in which the steering system 102 includes a third intermediate gear set 602. In the illustrated example of FIG. 6B, the third intermediate gear set 602 includes the third pinion 222 and a third intermediate gear 604. Accordingly, the third pinion and the third intermediate gear 604 are aligned along the third axis of rotation 227 (FIG. 2).

The steering system 102 also includes a fourth pinion 606 engaged with the third intermediate gear 604. In the illustrated example of FIG. 6B, the third intermediate gear 604 and the fourth pinion 606 are positioned on a first side of the third geometric plane (e.g., a same side of the third geometric plane as the second pinion 218) and aligned in the second geometric plane or a fourth geometric plane. Further, the engagement between the fourth pinion 606 and the third intermediate gear 604 provides a fourth gear reduction. In the illustrated example of FIG. 6B, the third intermediate gear 604 has a smaller diameter than the second intermediate gear 220 to avoid interfering with the second gear set 212.

In the illustrated example of FIG. 6B, to support the third intermediate gear set 602, the steering system 102 includes a sixth bearing journal 608 and a seventh bearing journal 610. The sixth bearing journal 608 is positioned on a second side of the third geometric plane opposite the first side and/or within a circumference of the third pinion 222. The seventh bearing journal 610 is positioned on the first side of the third geometric plane between the third pinion 222 and the third intermediate gear 604. In some examples, another bearing journal is positioned within a circumference of the third intermediate gear 604 and/or on an opposite side of the third intermediate gear 604 from the seventh bearing journal 610.

FIG. 6C illustrates another example implementation of the steering system 102 of FIG. 5 in which the third intermediate gear 604 and the fourth pinion 606 are positioned on a second side of the third geometric plane (e.g., an opposite side of the third pinion 222 relative to FIG. 6B). In the illustrated example of FIG. 6C, a diameter of the third intermediate gear 604 is not limited to being smaller than the diameter of the second intermediate gear 220 to avoid interfering with the second gear set 212. Instead, the diameter of the third intermediate gear 604 can be greater than the diameter of the second intermediate gear 220 so long as the third intermediate gear 604 avoids interfering with the first pinion 214, the ring gear 206, the ball nut 204, and/or the worm gear 202.

In the illustrated example of FIG. 6C, to support the third intermediate gear set 602, the steering system 102 includes an eighth bearing journal 612, a ninth bearing journal 614, and a tenth bearing journal 616. The eighth bearing journal 612 is positioned on the first side of the third geometric plane and/or within a circumference of the third pinion 222. The ninth bearing journal 614 is positioned on the second side of the third geometric plane between the third pinion 222 and the third intermediate gear 604. The tenth bearing journal 616 is positioned within a circumference of the third intermediate gear 604 and/or on an opposite side of the third intermediate gear 604 from the ninth bearing journal 614.

In some examples, the fourth pinion 606 is operatively coupled to the motor 122 (e.g., similar to the third pinion 222 in FIG. 6A). In some examples, the fourth pinion 606 is part of another intermediate gear set. Thus, although the steering system 102 of FIG. 6B includes three intermediate gear sets 210, 212, 602, it should be appreciated that the steering system 102 could include more than three intermediate gear sets 210, 212, 602 to increase the gear reduction ratio provided by the steering system 102. For example, the steering system 102 can include twenty secondary intermediate gears and associated pinions meshed in series between the motor 122 and the ring gear 206 and aligned along parallel rotational axes and parallel planes in the same manner as the first, second, and third intermediate gear sets 210, 212, 602 so long as a last pinion or intermediate gear in the series meshes with the ring gear 206. Advantageously, the quantity of intermediate gear sets 210, 212, 602 enables a size of the intermediate gear sets 210, 212, 602 to be relatively small while providing a significant combined gear reduction (e.g., greater than 100:1). Thus, the steering system 102 enables sufficient torque to be generated for heavier vehicles over a small area for adaptability in crowded under-hood environments.

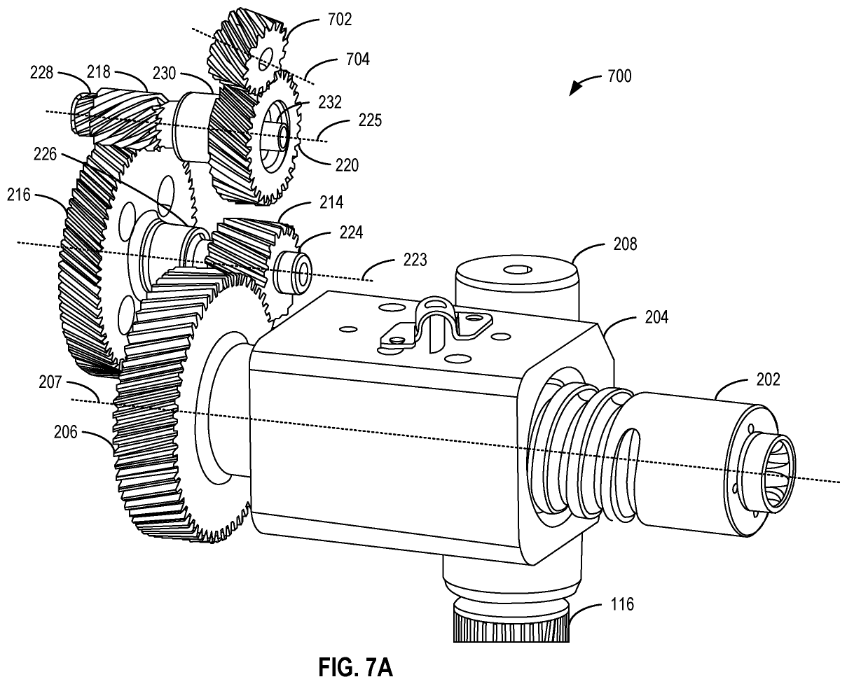

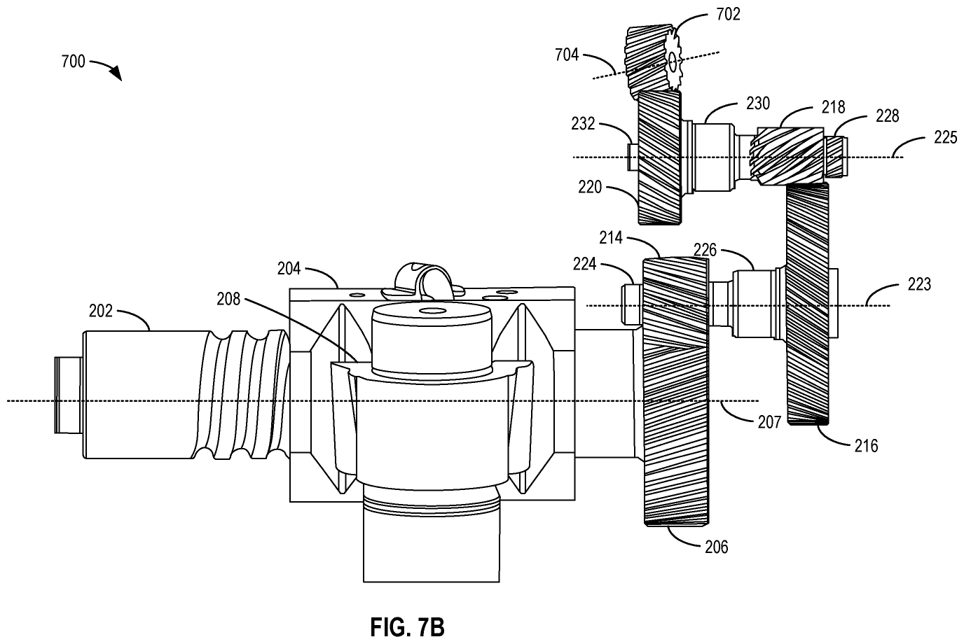

FIG. 7A illustrates a portion of another steering system 700 that can be implemented in a vehicle associated with the under-hood environment 100 of FIG. 1. FIG. 7B illustrates another view of the steering system 700 of FIG. 7A. In the illustrated examples of FIGS. 7A-7B, the steering system 700 includes the splined shaft 116, the worm gear 202, the ball nut 204, the ring gear 206, the sector gear 208, the first pinion 214, the first intermediate gear 216, the second pinion 218, the second intermediate gear 220, the first bearing journal 224, the second bearing journal 226, the third bearing journal 228, the fourth bearing journal 230, and the fifth bearing journal 232 discussed above. Accordingly, the worm gear 202 and the ring gear 206 are aligned along the first axis of rotation 207; the first pinion 214 and the first intermediate gear are aligned along the second axis of rotation 223; and second pinion 218 and the second intermediate gear 220 are aligned along the third axis of rotation 225.

In the illustrated examples of FIGS. 7A-7B, the steering system 700 also includes a fifth pinion 702. The fifth pinion 702 is aligned along a fifth axis of rotation 704.

In the illustrated examples of FIGS. 7A-7B, the fifth axis of rotation 704 is aligned non-parallel to the first axis of rotation 207, the second axis of rotation 223, and/or the third axis of rotation 225. More particularly, in the illustrated example of FIGS. 7A-7B, gear teeth of the fourth pinion 702 are positioned at a different angle (e.g., relative to a face of the third pinion 702) compared to gear teeth of the third pinion 222 of FIGS. 2, 3, 5, and 6A-6C. As a result, the fifth pinion 702 and an intermediate gear (e.g., the intermediate gear 604 (FIGS. 6A and/or 6B)) or a motor (e.g., the motor 122 (FIGS. 1 and/or 6A) fixed to the third pinion 702 are aligned along the fifth axis of rotation 704 instead of the fourth axis of rotation 227 of FIG. 2. As such, the steering system 700 occupies a different area than the steering system 102 of FIG. 2 and, thus, may be utilized in different vehicles and/or a different area of the under-hood environment 100 of FIG. 1.

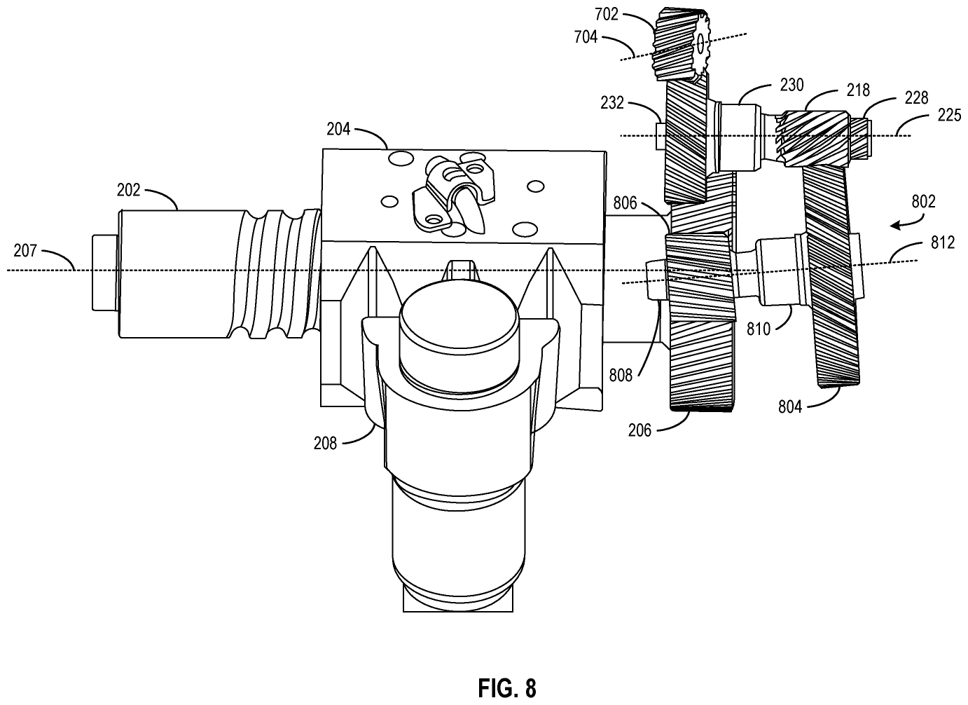

FIG. 8 illustrates a portion of another steering system 800 that can be implemented in a vehicle associated with the under-hood environment 100 of FIG. 1. In the illustrated example of FIG. 8, the steering system 800 includes the worm gear 202, the ball nut 204, the ring gear 206, the sector gear 208, the second pinion 218, the second intermediate gear 220, the third bearing journal 228, the fourth bearing journal 230, the fifth bearing journal 232, and the fifth pinion 702 discussed above. Accordingly, the worm gear 202 and the ring gear 206 are aligned along the first axis of rotation 207; the second pinion 218 and the second intermediate gear 220 are aligned along the third axis of rotation 225; and the fifth pinion 702 is aligned along the fifth axis of rotation 704.

In the illustrated example of FIG. 8, the steering system 800 also includes a fourth intermediate gear set 802 including a fourth intermediate gear 804 and a sixth pinion 806. The fourth intermediate gear set 802 also includes a ninth journal bearing 808 and a tenth journal bearing 810. Accordingly, the ninth and tenth journal bearings 808, 810 can be positioned in respective sleeves or shells for support while enabling the fourth intermediate gear set 802 to rotate. In the illustrated example of FIG. 8, the fourth intermediate gear set 802 is aligned along a sixth axis of rotation 812. In the illustrated example of FIGS. 8, the sixth axis of rotation 812 is non-parallel to the first axis of rotation 207, the third axis of rotation 225, and/or the fifth axis of rotation 704 to enable the steering system 800 to fit in a different area of the under-hood environment 100 of FIG. 1 and/or in under-hood environments of other vehicles. In some examples, the sixth axis of rotation 812 is parallel to the fifth axis of rotation 704.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one

B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

From the foregoing, it will be appreciated that example systems, methods, apparatus, and articles of manufacture have been disclosed that provide a rotary assist apparatus for RCB steering gears. As such, the RCB steering gears are able to generate steering power that is sufficient for heavier vehicles, such as trucks, while using electrical power steering. Further, the rotary assist apparatus provides a versatile layout that is advantageous for implementation within different under-hood environments.

Rotary assist apparatus for recirculating ball steering gears are disclosed herein. Further examples and combinations thereof include the following:

Example 1 includes a vehicle steering system comprising a worm gear, a ring gear fixed to an end of the worm gear, a ball nut surrounding a portion of the worm gear, the ball nut including ball bearings and ball guides, a first intermediate gear fixed to a first pinion, the first intermediate gear and the first pinion aligned along a first axis of rotation, the first pinion engaged with the ring gear, a second intermediate gear fixed to a second pinion, the second intermediate gear and the second pinion aligned along a second axis of rotation different than the first axis of rotation, the second pinion engaged with the first intermediate gear, a motor fixed to a third pinion, the third pinion engaged with the second intermediate gear or a third intermediate gear, the motor to rotate the worm gear to translate the ball nut, and a sector gear engaged with the ball nut, the sector gear to rotate as the ball nut translates.

Example 2 includes the vehicle steering system of example 1, further including a fourth pinion fixed to the third intermediate gear, wherein the third pinion is engaged with the third intermediate gear, and wherein the fourth pinion is engaged with the second intermediate gear.

Example 3 includes the vehicle steering system of example 1, further including a bearing journal for the second intermediate gear and the second pinion, the bearing journal positioned at least one of within a circumference of the second intermediate gear or on a side of the second intermediate gear opposite the second pinion.

Example 4 includes the vehicle steering system of example 3, wherein the bearing journal is a first bearing journal, further including a second bearing journal for the second intermediate gear and the second pinion, the second bearing journal positioned on an opposite side of the second intermediate gear from the first bearing journal.

Example 5 includes the vehicle steering system of example 4, further including a third bearing journal for the second intermediate gear and the second pinion, the third bearing journal positioned between the second intermediate gear and the second pinion.

Example 6 includes the vehicle steering system of example 1, further including a bearing journal for the first intermediate gear and the first pinion, the bearing journal positioned on a side of the first pinion opposite the first intermediate gear.

Example 7 includes the vehicle steering system of example 6, wherein the bearing journal is a first bearing journal, further including a second bearing journal for the first intermediate gear and the first pinion, the second bearing journal positioned between the first intermediate gear and the first pinion.

Example 8 includes the vehicle steering system of example 1, wherein the first intermediate gear and the second pinion are aligned along a geometric plane, and wherein the second intermediate gear and the first pinion are positioned on a same side of the geometric plane.

Example 9 includes the vehicle steering system of example 1, wherein the first intermediate gear includes a first diameter, and wherein the second intermediate gear includes a second diameter smaller than the first diameter.

Example 10 includes the vehicle steering system of example 1, wherein the end of the worm gear is a first end of the worm gear, further including an input shaft to couple a steering shaft of a vehicle to a second end of the worm gear.

Example 11 includes the vehicle steering system of example 1, wherein the second axis of rotation is parallel to the first axis of rotation.

Example 12 includes the vehicle steering system of example 11, wherein the worm gear and the ring gear are aligned along a third axis of rotation parallel to the first axis of rotation, and wherein the motor and the third pinion are aligned along a fourth axis of rotation parallel to the third axis of rotation.

Example 13 includes an apparatus comprising a worm gear fixed to a ring gear, a first gear set including a pinion of a motor engaged with a first intermediate gear, a second gear set including a pinion of the first intermediate gear engaged with a second intermediate gear, a third gear set including a pinion of the second intermediate gear engaged with the ring gear or a third intermediate gear, and a fourth gear set including a ball nut engaged with a portion of the worm gear, the ball nut to translate as the worm gear rotates.

Example 14 includes the apparatus of example 13, further including a fifth gear set when the pinion of the second intermediate gear is engaged with the third intermediate gear, the fifth gear set including the third intermediate gear and a pinion of the third intermediate gear, the pinion of the third intermediate gear engaged with the ring gear.

Example 15 includes the apparatus of example 13, further including a first bearing disposed between the first gear set and the second gear set, and a second bearing disposed on an opposite side of the second gear set relative to the first bearing.

Example 16 includes the apparatus of example 13, wherein the first intermediate gear and the pinion of the first intermediate gear are aligned along a first axis of rotation, wherein the ring gear and the worm gear are aligned a second axis of rotation parallel to the first axis of rotation.

Example 17 includes an apparatus comprising a worm gear fixed to a ring gear, the worm gear and the ring gear aligned along a first axis of rotation, a first intermediate gear fixed to a first pinion, the first intermediate gear and the first pinion aligned along a second axis of rotation parallel to the first axis of rotation, the first pinion engaged with the ring gear, and a motor fixed to a second pinion, the motor and the second pinion aligned along a third axis of rotation parallel to the second axis of rotation, the second pinion engaged with the first intermediate gear or a second intermediate gear.

Example 18 includes the apparatus of example 17, wherein the second pinion is engaged with the second intermediate gear, the second intermediate gear fixed to a third pinion, the third pinion engaged with the first intermediate gear or a third intermediate gear.

Example 19 includes the apparatus of example 18, wherein the third pinion is engaged with the third intermediate gear, the third intermediate gear fixed to a fourth pinion, the fourth pinion engaged with the first intermediate gear.

Example 20 includes the apparatus of example 17, wherein a placement of the second axis of rotation and the third axis of rotation is orbital relative to the first axis of rotation.

The following claims are hereby incorporated into this Detailed Description by this reference. Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

What is claimed is:

1. A vehicle steering system comprising:
a worm gear;
a ring gear fixed to an end of the worm gear;
a ball nut surrounding a portion of the worm gear, the ball nut including ball bearings and ball guides;
a first intermediate gear fixed to a first pinion, the first intermediate gear and the first pinion aligned along a first axis of rotation, the first pinion engaged with the ring gear;
a second intermediate gear fixed to a second pinion, the second intermediate gear and the second pinion aligned along a second axis of rotation different than the first axis of rotation, the second pinion engaged with the first intermediate gear;
a motor fixed to a third pinion, the third pinion engaged with the second intermediate gear or a third intermediate gear, the motor to rotate the worm gear to translate the ball nut; and
a sector gear engaged with the ball nut, the sector gear to rotate as the ball nut translates.

2. The vehicle steering system of claim 1, further including a fourth pinion fixed to the third intermediate gear, wherein the third pinion is engaged with the third intermediate gear, and wherein the fourth pinion is engaged with the second intermediate gear.

3. The vehicle steering system of claim 1, further including a bearing journal for the second intermediate gear and the second pinion, the bearing journal positioned at least one of within a circumference of the second intermediate gear or on a side of the second intermediate gear opposite the second pinion.

4. The vehicle steering system of claim 3, wherein the bearing journal is a first bearing journal, further including a second bearing journal for the second intermediate gear and the second pinion, the second bearing journal positioned on an opposite side of the second intermediate gear from the first bearing journal.

5. The vehicle steering system of claim 4, further including a third bearing journal for the second intermediate gear and the second pinion, the third bearing journal positioned between the second intermediate gear and the second pinion.

6. The vehicle steering system of claim 1, further including a bearing journal for the first intermediate gear and the first pinion, the bearing journal positioned on a side of the first pinion opposite the first intermediate gear.

7. The vehicle steering system of claim 6, wherein the bearing journal is a first bearing journal, further including a second bearing journal for the first intermediate gear and the first pinion, the second bearing journal positioned between the first intermediate gear and the first pinion.

8. The vehicle steering system of claim 1, wherein the first intermediate gear and the second pinion are aligned along a geometric plane, and wherein the second intermediate gear and the first pinion are positioned on a same side of the geometric plane.

9. The vehicle steering system of claim 1, wherein the first intermediate gear includes a first diameter, and wherein the second intermediate gear includes a second diameter smaller than the first diameter.

10. The vehicle steering system of claim 1, wherein the end of the worm gear is a first end of the worm gear, further including an input shaft to couple a steering shaft of a vehicle to a second end of the worm gear.

11. The vehicle steering system of claim 1, wherein the second axis of rotation is parallel to the first axis of rotation.

12. The vehicle steering system of claim 11, wherein the worm gear and the ring gear are aligned along a third axis of rotation parallel to the first axis of rotation, and wherein the motor and the third pinion are aligned along a fourth axis of rotation parallel to the third axis of rotation.

13. An apparatus comprising:
a worm gear fixed to a ring gear;
a first gear set including a pinion of a motor engaged with a first intermediate gear;
a second gear set including a pinion of the first intermediate gear engaged with a second intermediate gear;
a third gear set including a pinion of the second intermediate gear engaged with the ring gear or a third intermediate gear; and
a fourth gear set including a ball nut engaged with a portion of the worm gear, the ball nut to translate as the worm gear rotates.

14. The apparatus of claim 13, further including a fifth gear set when the pinion of the second intermediate gear is engaged with the third intermediate gear, the fifth gear set including the third intermediate gear and a pinion of the third intermediate gear, the pinion of the third intermediate gear engaged with the ring gear.

15. The apparatus of claim 13, further including:
a first bearing disposed between the first gear set and the second gear set; and
a second bearing disposed on an opposite side of the second gear set relative to the first bearing.

16. The apparatus of claim 13, wherein the first intermediate gear and the pinion of the first intermediate gear are aligned along a first axis of rotation, wherein the ring gear and the worm gear are aligned a second axis of rotation parallel to the first axis of rotation.

17. An apparatus comprising:
a worm gear fixed to a ring gear, the worm gear and the ring gear aligned along a first axis of rotation;
a first intermediate gear fixed to a first pinion, the first intermediate gear and the first pinion aligned along a second axis of rotation parallel to the first axis of rotation, the first pinion engaged with the ring gear; and
a motor fixed to a second pinion, the motor and the second pinion aligned along a third axis of rotation parallel to the second axis of rotation, the second pinion engaged with the first intermediate gear or a second intermediate gear.

18. The apparatus of claim 17, wherein the second pinion is engaged with the second intermediate gear, the second intermediate gear fixed to a third pinion, the third pinion engaged with the first intermediate gear or a third intermediate gear.

19. The apparatus of claim 18, wherein the third pinion is engaged with the third intermediate gear, the third intermediate gear fixed to a fourth pinion, the fourth pinion engaged with the first intermediate gear.

20. The apparatus of claim 17, wherein a placement of the second axis of rotation and the third axis of rotation is orbital relative to the first axis of rotation.
